(19) United States
(12) Patent Application Publication
(10) Pub. No.: US 2023/0325737 A1
(43) Pub. Date: Oct. 12, 2023

(54) METHOD AND SYSTEM FOR PREDICTING POST-EARTHQUAKE REPAIR OF BUILDING GROUPS IN COMMUNITY

(71) Applicant: University of Science and Technology Beijing, Beijing (CN)

(72) Inventors: Zhen XU, Beijing (CN); Furong ZHANG, Beijing (CN); Xintian HAO, Beijing (CN)

(73) Assignee: University of Science and Technology Beijing, Beijing (CN)

(21) Appl. No.: 17/954,357

(22) Filed: Sep. 28, 2022

(30) Foreign Application Priority Data
Apr. 8, 2022 (CN) 202210362500.4

(51) Int. Cl. G06Q 10/06

(52) U.S. Cl. CPC G06Q 10/06313; G06Q 50/26

(57) ABSTRACT

A method and system for predicting post-earthquake repair of building groups in community are provided. The method includes: obtaining seismic damage states, building functions, and building areas of building groups in the community; determining a repair priority of each building based on functional classifications of the buildings; calculating a building repair workload considering the seismic damage states and building areas of the building groups in the community, and developing an individual-building repair model for simulating the repair process of an individual building under certain resource conditions; and developing a community building group repair resource allocation model and a community building group repair system dynamics model to predict the repair process of the building groups in the community at different levels of resource availability. The technical solution of the present invention can simulate the post-earthquake repair process of the building groups in the community.

### CROSS REFERENCE TO THE RELATED APPLICATIONS

This application is based upon and claims priority to Chinese Patent Application No. 202210362500.4, filed on Apr. 8, 2022, the entire contents of which are incorporated herein by reference.

### TECHNICAL FIELD

The present invention relates to the technical field of post-earthquake repair of building groups in a community, and in particular to a method and system for predicting post-earthquake repair of building groups in a community.

### BACKGROUND

Predicting the post-earthquake repair process of building groups in a community can provide support for the decision-making of community resilience. On the one hand, by considering the resource dispatch and allocation process involved in the community repair process, more refined and more reasonable prediction of the community repair process with more comprehensive elements can be obtained. On the other hand, providing the demand for resources such as workers and materials in different stages of post-earthquake repair will help reduce the redundancy and waste of repair resources, and carry out post-earthquake building repair work in the community more efficiently, and formulate the strategies for improving community resilience.

The post-earthquake repair process in a community is complex and involves numerous factors, which cannot be predicted accurately based on traditional methods. Although the post-earthquake loss in a community can be regarded as a simple superposition of the losses of individual buildings, for the building repair project, due to the limited repair resources of the community, the implementation of the repair project is actually influenced by the scope of the project, the complexity of the project, the project environment, project management, etc. For the actual post-earthquake repair process of the community, more practical factors need to be considered to make predictions.

Many studies in recent years have used system dynamics methods for the development, change and repair of public services (such as health care, express logistics), critical infrastructure (such as power distribution networks, water supply networks), or road networks in a community (Cheng Jialong. Research on emergency resource allocation model for construction engineering projects based on system dynamics [D]. Xiangtan University, 2018; Khanmohammadi S, Farahmand H, Kashani H. A system dynamics approach to the seismic resilience enhancement of hospitals [J]. International journal of disaster risk reduction, 2018, 31: 220-233; Diaz R, Behr J G, Longo F, et al. Supply Chain Modeling in the Aftermath of a Disaster: A System Dynamics Approach in Housing Recovery [J]. IEEE Transactions on Engineering Management, 2019). However, there are few studies on predictions of multiple factors (such as workers, equipment, materials, funds, repair progress, etc.) in the post-earthquake repair process of communities.

To sum up, there is currently a lack of a prediction solution for the post-earthquake repair process of building groups in a community.

### SUMMARY

The present invention provides a method and system for predicting the post-earthquake repair process of building groups in a community, so as to solve the technical problem that there is currently a lack of a prediction solution for the post-earthquake repair process of building groups in a community.

To solve the foregoing technical problem, the present invention provides the following technical solutions.

In one aspect, the present invention provides a method for predicting a post-earthquake repair process of building groups in a community, including:
obtaining seismic damage states, building functions, and building areas of building groups in the community;
determining a repair priority of each building based on functional classifications of the buildings;
calculating a building repair workload considering the seismic damage states and building areas of the building groups in the community, and developing an individual-building repair model for simulating the repair process of an individual building under certain resource conditions; and
developing a community building group repair resource allocation model and a community building group repair system dynamics model, summarizing the repair progresses of all buildings belonging to this classification in the community according to different functional classifications, and calculating functional completeness of a functional classification of the community to predict the repair process of the building groups in the community at different levels of resource availability.

Further, the determining the repair priority of each building based on functional classifications of the buildings includes:
determining five repair priorities based on the functional classifications of the buildings, including:
P0: Buildings that meet preset standards in terms of correlation with post-earthquake emergency management or rescue;
P1: Urban housing or buildings that can be used for emergency and evacuation shelters;
P2: Infrastructure and municipal utilities:
P3: Market, service or industrial facilities that meet preset standards in terms of the importance in providing basic life necessities to people in the disaster area and restoring production;
P4: Markets, services or industrial facilities that do not belong to P3 and can be restored through ecology;
where the repair urgency decreases as the priority level increases from P0 to P4.

Further, the seismic damage states of the building groups in the community includes: the number of damaged structural and nonstructural components; and the types of damaged structural and nonstructural components.

Further, the calculating a building repair workload considering the seismic damage states and building areas of the building groups in the community includes:
calculating a building repair area considering the seismic damage states and building areas of the building groups in the community, and taking the repair area as the repair workload, where the repair area, i.e., areaᵣₑₚ is calculated as:

$${area}_{rep} = \frac{{\sum }_{i = 0}^{nStrCpn} {q}_{i , dmg}^{StrCpn} + β {\sum }_{i = 0}^{nNonStrCpn} {q}_{i , dmg}^{NonStrCpn}}{{\sum }_{i = 0}^{nCpn} {q}_{i}} \cdot {area}_{blg}$$

where nStrCpn represents the number of types of structural components in a building; nNonStrCpn represents the number of types of nonstructural components in a building; area_{blg} grepresents the area of the building; q_{i,dmg}^{StrCpn} represents the number of damaged structural components of the i-th type; q_{i,dmg}^{NonstrCpn} represents the number of damaged nonstructural components of the i-th type; qᵢ represents the number of structural and nonstructural components of the i-th type; β is the workload reduction factor used for calculating the workload of nonstructural components; and nCpn represents the number of types of components.

Further, the developing the individual-building repair model includes:
developing the system dynamics models of workers, equipment, materials, funds and repair progress for individual-building repair respectively, by which the dynamic interactions among the above factors can be analyzed; and establishing system dynamics simulation equations;
where the simulation equations include:

Worker demand=(remaining workload>0)?((emergency funds/(unit project cost*average worker efficiency))>(expected number of on-the-job workers+total number of on-the-job workers))?(expected number of on-the-job workers):((emergency funds/(unit project cost*average worker efficiency)>total number of on-the-job workers)?(emergency funds/(unit project cost*average worker efficiency*day( )-total number of on-the-job workers):(0)):(0);

Worker construction speed=total number of on-the-job workers*actual worker efficiency*number of worker teams;

Equipment demand=(remaining workload>0)?((emergency funds/(unit project cost*average equipment efficiency))>(expected amount of on-the-job equipment+total amount of on-the-job equipment))?(expected amount of on-the-job equipment):((emergency funds/(unit project cost*average equipment efficiency)>total amount of on-the-job equipment)?(emergency funds/(unit project cost*average equipment efficiency*day( )-total amount of on-the-job equipment):(0)):(0);

Equipment construction speed=total amount of on-the-job equipment*actual equipment efficiency*number of equipment teams;

Material supply rate=(available materials/material consumption per unit project)/day( );

Material consumption rate=(expected material input>0 && remaining workload>0)?((emergency funds>=remaining workload*material consumption per unit project*unit material cost)?(remaining workload*material consumption per unit project/day( )):((emergency funds/(unit project cost+0.001))*material consumption per unit project/day( ))):0;

Fund demand=remaining workload>0?((minimum guarantee of funds>emergency funds)?(minimum guarantee of funds−emergency funds):0):0;

Fund consumption rate=remaining workload>0.05?(unit worker cost*total number of on-the-job workers+unit equipment cost*total amount of on-the-job equipment)/day( )+material consumption rate*unit material cost:0;

Remaining repair time=expected repair time*(remaining workload/total repair workload);

Actual construction speed=(remaining workload>0)?((comprehensive construction speed>remaining workload/day( ))?(remaining workload/day( )):(comprehensive construction speed)):(0);

Repair progress=1−remaining workload/total repair workload;
where day( ) is an auxiliary amount added to adjust the unit of the variable, which is valued as 1, in the unit of day.

Further, the developing the community building group repair resource allocation model includes:
traversing all the buildings to determine the repair progress of each individual building;
calculating actual resource demands of unrepaired buildings and classifying and queuing the unrepaired buildings according to their repair priorities; recovering workers and equipment from completely repaired buildings;
traversing the repair queues of corresponding priorities according to the priority from high level to low level;
determining whether currently available resources satisfy the resource demands of repair projects in the queues;
if there is a surplus of resources after the resource allocation, further allocating the remaining resources to buildings that are in the same priority queue but are lagging in their repair progress; or, if the currently available resources do not satisfy the resource demand, allocating all resources equally, so that the repair of all buildings in this priority queue can begin.

Further, the repair progress is calculated as:

Fⱼⁱ=Fᵣₑₛⁱ+(1−Fᵣₑₛⁱ)*Pᵣₑₚⁱ
where Fⱼⁱ represents the repair progress of an i-th building of a j-th functional classification; Fᵣₑₛⁱ represents a post-earthquake functional completeness of the i-th building, i.e., the ratio of undamaged area of the building to its total area; Pᵣₑₚⁱ represents the ratio of repaired area of the building to its damaged area;
the functional completeness is calculated as:

$${F}_{c , func}^{j} = \frac{1}{{nBlg}^{j}} {\sum }_{i = 1}^{{nBlg}^{j}} {F}_{j}^{i}$$

where F_{c,func}^{j} represents the functional completeness of the j-th functional classification of the community; nBlg^{j} represents the total number of buildings of the j-th functional classification.

Further, the equations for the system dynamics model for the repair process of the building groups in the community include:

Total allocable workers=min(worker demand, max(0, maximum number of workers−number of on-the-job workers−number of recovered workers))/(delay in worker dispatch)+number of recovered workers;

Total allocable equipment=min(equipment demand, max(0, maximum amount of equipment−amount of on-the-job equipment−amount of recovered equipment))/(delay in equipment dispatch)+amount of recovered equipment;

Total allocable materials=min (materials demand/delay in material dispatch, maximum number of materials).

Further, the predicting the repair process of the building groups in the community at different levels of resource availability includes: selecting three parameters of delay in material dispatch, maximum amount of equipment and maximum number of workers, limiting the total amount of community repair resources, and designing three resource levels of high, medium and low, allocating limited repair resources according to repair priorities of buildings, simulating the post-earthquake repair process of building groups in the community, and displaying the repair progress and resource allocation at different levels of resource availability.

In another aspect, the present invention further provides a system for predicting a post-earthquake repair process of building groups in a community, including:
a data preparing module, configured to obtain seismic damage states, building functions, and building areas of building groups in the community;
a building repair priority determining module, configured to determine the repair priority of each building based on functional classifications of the buildings;
a post-earthquake individual-building repair model developing module, configured to calculate a building repair workload considering the seismic damage states and building areas of the building groups in the community, and develop an individual-building repair model for simulating the repair process of an individual building under certain resource conditions; and
a community building group repair resource allocation model and post-earthquake community building group repair model developing module, configured to develop a community building group repair resource allocation model and a community building group repair system dynamics model, summarizing the repair progresses of all buildings belonging to this classification in the community according to different functional classifications, and calculating functional completeness of a functional classification of the community to predict the repair process of the building groups in the community at different levels of resource availability.

In yet another aspect, the present invention further provides an electronic device, including a processor and a memory, where the memory stores at least one instruction, and the instruction is loaded and executed by the processor to implement the above method.

In still another aspect, the present invention further provides a computer-readable storage medium storing at least one instruction, the instruction being loaded and executed by a processor to implement the above method.

The technical solution of the present invention brings about at least the following beneficial effects:

Considering the resource dispatch and allocation process involved in the community repair process, the technical solution of the present invention can predict and simulate the demand for resources such as workers and materials in different stages of post-earthquake repair, which is conducive to reducing the redundancy and waste of repair resources. Moreover, the repair progress and resource allocation at different levels of resource availability can be provided to simulate the allocation of repair resources during the community repair process, thereby providing decision-making support for the post-earthquake emergency repair plans. The decision makers can therefore be supported to formulate efficient and accurate post-earthquake emergency repair plans.

### BRIEF DESCRIPTION OF THE DRAWINGS

In order to make the technical solutions of embodiments of the present invention more clear, drawings to be used for description of embodiments will be introduced briefly hereinafter. Obviously, drawings used in the following description are merely some embodiments of the present invention. Those skilled in the art also can conclude other drawings based on these drawings without paying creative labor.

FIG. 1 is a schematic execution flow diagram of a method for predicting a post-earthquake repair process of building groups in a community according to an embodiment of the present invention;

FIG. 2 is a schematic diagram of a system dynamics model for workers according to an embodiment of the present invention;

FIG. 3 is a schematic diagram of a system dynamics model for equipment according to an embodiment of the present invention;

FIG. 4 is a schematic diagram of a system dynamics model for materials according to an embodiment of the present invention;

FIG. 5 is a schematic diagram of a system dynamics model for funds according to an embodiment of the present invention;

FIG. 6 is a schematic diagram of a system dynamics model for repair progress according to an embodiment of the present invention;

FIG. 7 is a schematic diagram of a community building group repair resource allocation model according to an embodiment of the present invention; and

FIG. 8 is a schematic diagram of a system dynamics model for community repair according to an embodiment of the present invention.

### DETAILED DESCRIPTION OF THE EMBODIMENTS

In order to make the object, technical solutions and advantages of the present invention more clear, the embodiments of the present invention will be described further in detail below with reference to the accompanying drawings.

### First Embodiment

This embodiment provides a method for predicting a post-earthquake repair process of building groups in a community. The method includes: obtaining seismic damage states, building functions, and building areas of building groups in the community; determining a repair priority of each building based on functional classifications of the buildings; calculating the repair workload considering the seismic damage states and building areas of the building groups in the community, and developing an individual-building repair model for simulating the repair process of an individual building under certain resource conditions; and developing a community building group repair resource allocation model and a community building group repair system dynamics model to predict the repair process of the building groups in the community at different levels of resource availability.

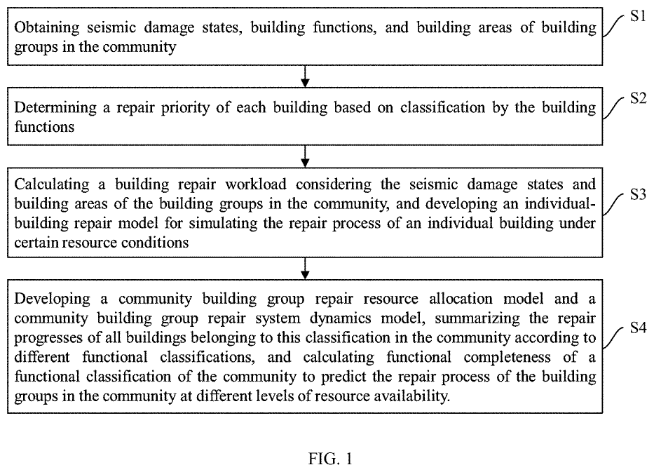

Specifically, as shown in FIG. 1, the execution flow of the method includes the following steps:

S1, obtaining seismic damage states, building functions, and building areas of building groups in the community.

The above data preparation can provide a data basis for determining the order of building repairs and calculating the repair workload. The seismic damage states of the building groups in the community includes: the number of damaged structural and nonstructural components; and the types of damaged structural and nonstructural components. Building functions can provide a reference for determining the repair priorities of buildings, and the seismic damage states and building areas of the building groups in the community can provide a data basis for calculating the repair workload.

S2, determining a repair priority of each building based on functional classifications of the buildings.

Specifically, in this embodiment, based on the functional classifications of the buildings, five repair priorities are determined and the five repair priorities include:
P0: Buildings that meet preset standards in terms of correlation with post-earthquake emergency management or rescue;
P1: Urban housing or buildings that can be used for emergency and evacuation shelters;
P2: Infrastructure and municipal utilities:
P3: Market, service or industrial facilities that meet preset standards in terms of the importance in providing basic life necessities to people in the disaster area and restoring production;
P4: Markets, services or industrial facilities that do not belong to P3 and can be restored through ecology;
where the repair urgency decreases as the priority level increases from P0 to P4.

S3, calculating the repair workload considering the seismic damage states and building areas of the building groups in the community, and developing an individual-building repair model for simulating the repair process of an individual building under certain resource conditions.

Specifically, in this embodiment, the workload is calculated by:

calculating a building repair area considering the seismic damage states and building areas of the building groups in the community, and taking the repair area as the repair workload, where the repair area, i.e., areaᵣₑₚ is calculated as:

$${area}_{rep} = \frac{{\sum }_{i = 0}^{nStrCpn} {q}_{i , dmg}^{StrCpn} + β {\sum }_{i = 0}^{nNonStrCpn} {q}_{i , dmg}^{NonStrCpn}}{{\sum }_{i = 0}^{nCpn} {q}_{i}} \cdot {area}_{blg}$$

where nStrCpn represents the number of types of structural components in a building; nNonStrCpn represents the number of types of nonstructural components in a building; area_{blg} grepresents the area of the building; q_{i,dmg}^{StrCpn} represents the number of damaged structural components of the i-th type; q_{i,dmg}^{NonStrCpn} represents the number of damaged nonstructural components of the i-th type; qᵢ represents the number of structural and nonstructural components of the i-th type; β is the workload reduction factor (valued as 0.5) used for calculating the workload of nonstructural components; and nCpn represents the number of types of components.

It should be noted that, considering that nonstructural components have less impact on building functions than structural components, and can be repaired during normal use of the structure, this embodiment makes a reduction during the calculation of the total workload.

Further, Step 3 of developing the individual-building repair model specifically includes: developing the system dynamics models of workers, equipment, materials, funds and repair progress for individual-building repair respectively, by which the dynamic interactions among the above factors can be analyzed; and establishing system dynamics simulation equations. The calculation equations involve a total of 101 variables, including 17 key state variables and 84 other auxiliary variables and system constants. The main calculation equations include:

Worker demand=(remaining workload>0)?((emergency funds/(unit project cost*average worker efficiency))>(expected number of on-the-job workers+total number of on-the-job workers))?(expected number of on-the-job workers):((emergency funds/(unit project cost*average worker efficiency)>total number of on-the-job workers)?(emergency funds/(unit project cost*average worker efficiency*day( )-total number of on-the-job workers):(0)):(0);

Worker construction speed (m²/d)=total number of on-the-job workers*actual worker efficiency*number of worker teams;

Equipment demand (set)=(remaining workload>0)?((emergency funds/(unit project cost*average equipment efficiency))>(expected amount of on-the-job equipment+total amount of on-the-job equipment))?(expected amount of on-the-job equipment):((emergency funds/(unit project cost*average equipment efficiency)>total amount of on-the-job equipment)?(emergency funds/(unit project cost*average equipment efficiency*day( ))-total amount of on-the-job equipment):(0)):(0);

Equipment construction speed (set)=total amount of on-the-job equipment*actual equipment efficiency*number of equipment teams;

Material supply rate (tons/d)=(available materials/material consumption per unit project)/day( );

Material consumption rate=(expected material input>0 && remaining workload>0)?((emergency funds>=remaining workload*material consumption per unit project*unit material cost)?(remaining workload*material consumption per unit project/day( )):((emergency funds/(unit project cost+0.001))*material consumption per unit project/day( )):0;

Fund demand (CNY)=remaining workload>0?((minimum guarantee of funds>emergency funds)?(minimum guarantee of funds−emergency funds):0):0;

Fund consumption rate (CNY/d)=remaining workload>0.05?(unit worker cost*total number of on-the-job workers+unit equipment cost*total amount of on-the-job equipment)/day( )+material consumption rate*unit material cost:0;

Remaining repair time (day)=expected repair time*(remaining workload/total repair workload);

Actual construction speed (m²/d)=(remaining workload>0)?((comprehensive construction speed>remaining workload/day( )?(remaining workload/day( ):(comprehensive construction speed)):(0);

Repair progress (in the unit of 1)=1−remaining workload/total repair workload;
where “(condition)?(expression 1):(expression 2)” is a logical operator, if the condition is true, expression 1 will be executed, otherwise expression 2 will be executed; “&&” is a logical union operator; “day( )” is an auxiliary quantity added to adjust the unit of the variable, valued as 1, and the unit is “day”; the unit of the variable is “1”, indicating that the variable is dimensionless.

S4, developing a community building group repair resource allocation model and a community building group repair system dynamics model, summarizing the repair progresses of all buildings belonging to this classification in the community according to different functional classifications, and calculating functional completeness of a functional classification of the community to predict the repair process of the building groups in the community at different levels of resource availability.

Specifically, in this embodiment, the developing the community building group repair resource allocation model includes:
traversing all the buildings to determine the repair progress of each individual building;
where the repair progress is calculated as:

Fⱼⁱ=Fᵣₑₛⁱ+(1−Fᵣₑₛⁱ)*Pᵣₑₚⁱ
where Fⱼⁱ represents the repair progress of an i-th building of a j-th functional classification; Fᵣₑₛⁱ represents a post-earthquake functional completeness of the i-th building, i.e., the ratio of undamaged area of the building to its total area; Pᵣₑₚⁱ represents the ratio of repaired area of the building to its damaged area;
the functional completeness F_{c,func}^{j} of the functional classification of the community is expressed as the average of repair progresses of all buildings of this classification and calculated as:

$${F}_{c , func}^{j} = \frac{1}{{nBlg}^{j}} {\sum }_{i = 1}^{{nBlg}^{j}} {F}_{j}^{i}$$

where nBlg^{j} represents the total number of buildings of the j-th functional classification.
calculating actual resource demands of unrepaired buildings and classifying and queuing the unrepaired buildings according to their repair priorities; recovering workers and equipment from completely repaired buildings;
traversing the repair queues of corresponding priorities according to the priority from high level to low level;
determining whether currently available resources satisfy the resource demands of repair projects in the queues;
if there is a surplus of resources after the resource allocation, further allocating the remaining resources to buildings that are in the same priority queue but are lagging in their repair progress; or, if the currently available resources do not satisfy the resource demand, allocating all resources equally, so that the repair of all buildings in this priority queue can begin.

Further, the community building group repair system dynamics model involves a total of 24 variables, including 6 key state variables and 18 other auxiliary variables and system constants. The main calculation equations include:

Total allocable workers (per day)=min (worker demand, max (0, maximum number of workers−number of on-the-job workers−number of recovered workers))/(delay in worker dispatch)+number of recovered workers;

Total allocable equipment (set/d)=min (equipment demand, max(0, maximum amount of equipment−amount of on-the-job equipment−amount of recovered equipment))/(delay in equipment dispatch)+amount of recovered equipment;

Total allocable materials (tons/d)=min(materials demand/delay in material dispatch, maximum number of materials)

Further, S4 of predicting the repair process of the building groups in the community at different levels of resource availability includes: selecting three parameters of delay in material dispatch, maximum amount of equipment and maximum number of workers, limiting the total amount of community repair resources, and designing three resource levels of high, medium and low, allocating limited repair resources according to repair priorities of buildings, simulating the post-earthquake repair process of building groups in the community, and displaying the repair progress and resource allocation at different levels of resource availability.

The implementation process of the method of this embodiment is further described below with an example of practical application.

A case study was performed to investigate the damage states of a total of 900 buildings in an area, as shown in Table 1. Generally, most of the framed residential or office buildings in the area are in moderate or extensive damage. For a light steel workshop structure, although the damage state of the structure is not serious, considering that it includes important nonstructural components such as production equipment, the structure is in a state of moderate damage, but it cannot fully represent its functional completeness.

TABLE 1
The seismic damage states of buildings

| | Frame-shear | Frame | Light steel | Steel |
|---|---|---|---|---|
| Damage state | wall structure | structure | workshop | structure |
| Intact | 0.0% | 0.0% | 0.0% | 0.0% |
| Slight damage | 0.0% | 8.2% | 100.0% | 11.9% |
| Moderate | 100.0% | 39.4% | 0.0% | 88.1% |
| damage | | | | |
| Extensive | 0.0% | 51.7% | 0.0% | 0.0% |
| damage | | | | |
| Collapse | 0.0% | 0.7% | 0.0% | 0.0% |

Collect the basic data such as building functions and building areas in this area. As shown in Table 2, the repair priority of each building was determined according to different functional classifications, and there are 53 buildings with P0 priority, 499 with P1 priority, 89 with P2 priority, 167 with P3 priority, and 92 with P4 priority.

TABLE 2
Repair priority

| Priority | Description | Instance |
|---|---|---|
| P0 | Buildings that meet preset standards | General hospitals, emergency |
| | in terms of correlation with post- | centers, CDCs, government |
| | earthquake emergency management or | agencies, etc. |
| | rescue | |
| P1 | Urban housing or buildings that can | Residence, dormitories, |
| | be used for emergency and evacuation | stadiums, colleges and |
| | shelters | universities, middle |
| | | schools, etc. |
| P2 | Infrastructure and municipal utilities | Structures for public utilities, |
| | | news and publishing, radio and |
| | | television, airports, etc. |
| P3 | Market, service or industrial facilities | Department stores, supermarkets, |
| | that meet preset standards in terms of | convenience stores, home building |
| | the importance in providing basic life | materials, shops, etc. |
| | necessities to people in the disaster | |
| | area and restoring production | |
| P4 | Markets, services or industrial | Chinese restaurants, cinemas, and |
| | facilities that do not belong to P3 and | buildings for ktv, parent-child |
| | can be restored through ecology | education, agriculture, forestry |
| | | and gardening, etc. |

For the post-earthquake repair process of an individual building, the repair area of the building is calculated according to the post-earthquake damage state. Since the structural components are roughly evenly distributed in the building, the proportion of the overall damage area of the building is roughly the same as the damage proportion of the structural components. Different types of nonstructural components have different effects on the repair project. For example, nonstructural components, such as independent chandeliers, home entertainment systems, etc. do not affect the functionality of the building, whereas important nonstructural components, such as infill walls and exterior walls, must be considered. However, because their workloads and importance are not as high as those of structural components and they can be repaired while the building is in normal use, a reduction is made during the calculation of total workload.

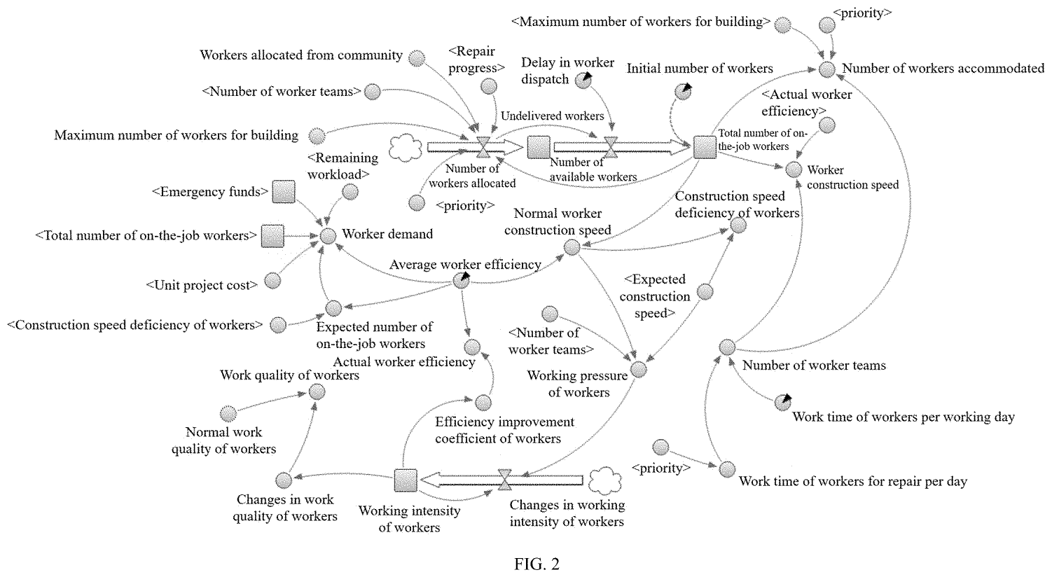

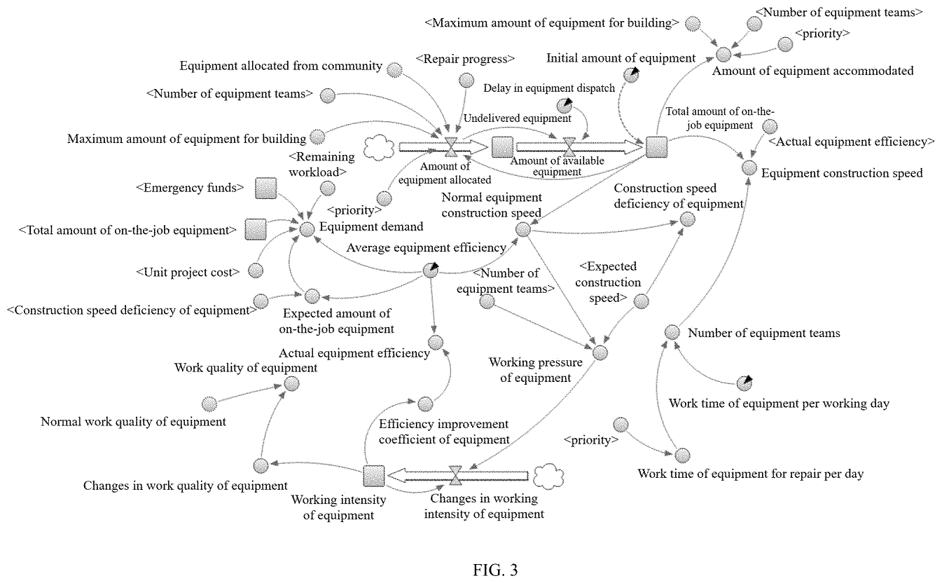

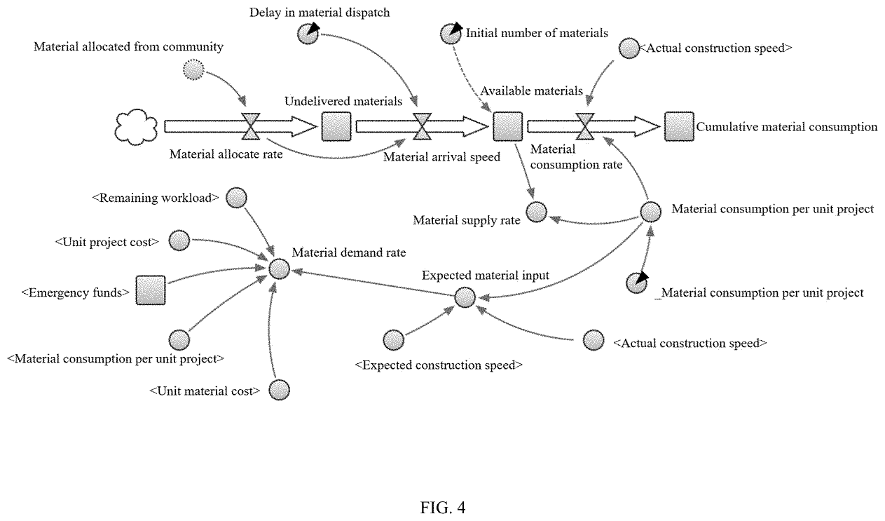

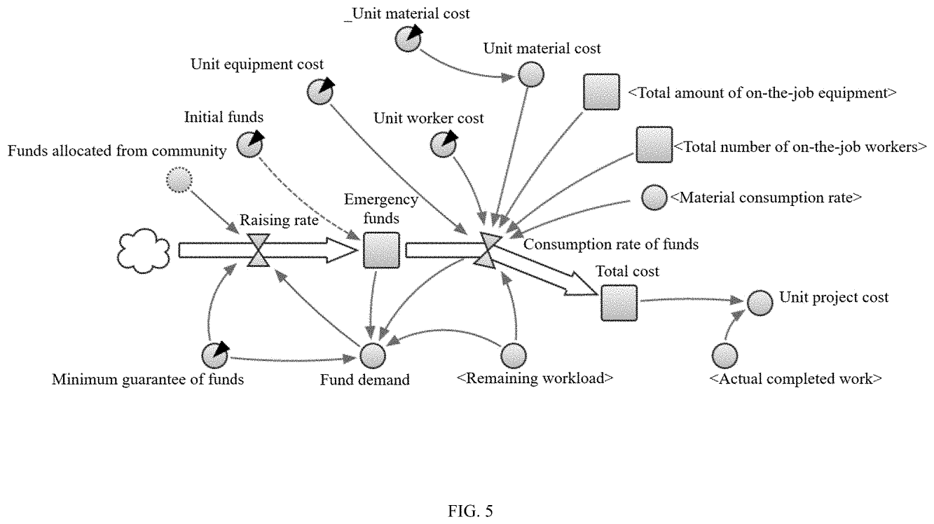

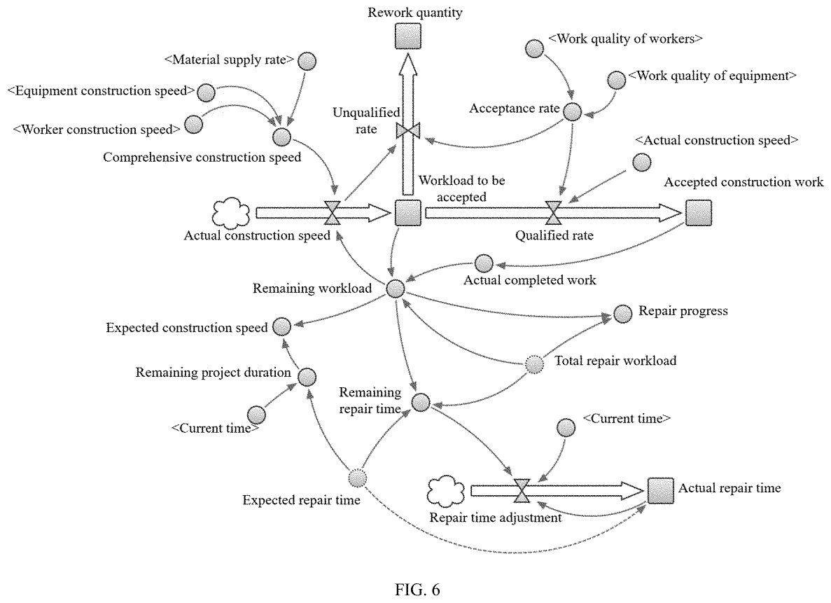

The system dynamics models of workers, equipment, materials, funds and repair progress are established respectively. As shown in FIGS. 2 to 6, in the models, the relationship between work efficiency, work quality and working intensity are considered during the calculation of the number of on-the-job workers and the amount of on-the-job equipment; the damage states of buildings, the current repair construction speed and the initial number of repair materials are considered during the calculation of the material demand; and the fund demand is dynamically calculated based on the number of allocated workers, the number of allocated equipment and the amount of delivered materials in the repair project. A total of 101 variables were involved therein, including 17 key state variables, and 84 other auxiliary variables and system constants. Referring to “Construction Engineering Building Materials and Cost Consulting” and “Repair Code”, and considering the actual situation of the project, the initial values of some constants and state variables in the models are defined.

Take a building with P3 as a case, based on the priority of the building, in order to complete the repair work as soon as possible, the work time of workers for repair per day was 12 h, and 2 teams of workers were required to work in shifts. The maximum number of workers that could be accommodated in the building was 229, with the initial number of workers being 50; the maximum amount of equipment items that could be accommodated in the building was 5 sets, with the initial amount of equipment being 0; the initial number of repair materials was 10 tons; and the minimum guarantee of funds was ten thousand CNY. The dispatch delay was set as 1 day for material delivery 2 days for personnel arrival, and 2 days for equipment transport. The average worker efficiency was 2.0 m²/d, and the average equipment efficiency was 50 m²/d. According to market conditions and quotas, the unit cost was set as 200 CNY/d for workers, 1,000 CNY/d for equipment and 1,200 CNY/d for materials. A maximum of 15 workers and 2 sets of equipment could be added to the building repair project every day. The allocation quota was set as 55 tons/d for repair materials and 350 thousand CNY/d for repair funds. The input of workers, equipment, materials, and funds and the repair progress during the repair process of the building are shown in Table 3:

TABLE 3
The input of workers, equipment, materials, and funds and the
repair progress during the repair process of the building

| | Repair | | | Material | Fund |
|---|---|---|---|---|---|
| Time | progress | | Equipment | consumption | consumption |
| (Day) | (%) | Workers | (Set) | (Tons) | (×10⁴ CNY) |
| 0 | 0.0% | 50 | 0 | 0.00 | 0.00 |
| 1 | 5.9% | 65 | 1 | 8.63 | 2.25 |
| 2 | 16.5% | 80 | 3 | 24.23 | 5.78 |
| 3 | 29.1% | 95 | 4 | 41.72 | 9.96 |
| 4 | 44.4% | 110 | 5 | 62.22 | 14.94 |
| 5 | 62.2% | 125 | 7 | 85.72 | 20.71 |
| 6 | 81.8% | 131 | 7 | 111.59 | 27.12 |
| 7 | 93.3% | 131 | 7 | 126.81 | 32.29 |
| 8 | 97.5% | 131 | 7 | 132.41 | 36.30 |
| 9 | 99.1% | 131 | 7 | 134.46 | 39.89 |
| 10 | 100% | 131 | 7 | 135.22 | 43.32 |

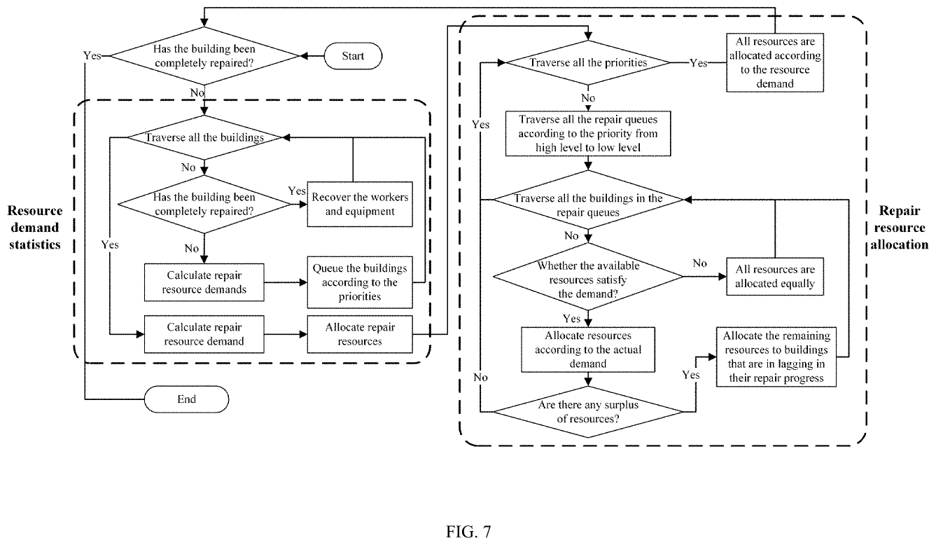

In the repair of building groups in a community, due to the different importance levels of buildings, repair resources should be preferentially allocated to buildings with important functions and greater impact, so that these buildings can be repaired first, so as to improve the restoration of the overall functionality of the community more quickly. As shown in FIG. 7, the process of allocating community repair resources to individual building repair projects is simulated. It can be ensured that high-priority buildings are repaired first, the repair projects of low-priority buildings are completed as soon as possible, and under the same priority, buildings with slower construction progress are allocated more resources.

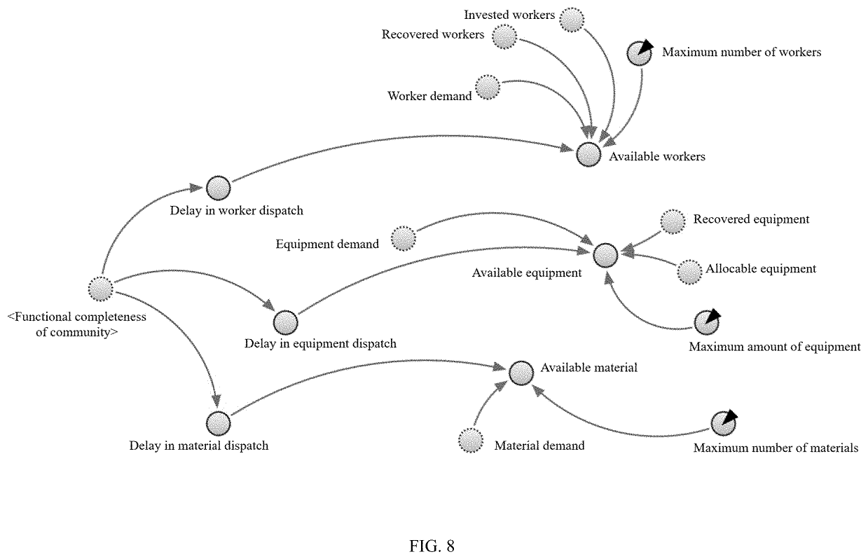

For the workers and equipment to be put into the repair work, since the accommodating capacity of construction workers and equipment in the disaster-stricken area is limited, the model limits the total allowable number of on-the-job workers and equipment. When the repair project of a building is completed, some workers and equipment invested in the building can continue to be invested in the repair project of other buildings, which is equivalent to “recovering” the resources of workers and equipment. Certainly, there is also a certain delay in arrival of workers and equipment at the damaged building to start construction. As shown in FIG. 8, a community repair resource allocation system dynamics model is developed to reflect the restoration resource dispatch and allocation process in the community.

To compare the effects of different resource allocation schemes on the overall repair progress, three parameters that have the most obvious effect on the repair progress, i.e., the delay in material dispatch, maximum amount of equipment, and maximum number of workers, were selected to analyze the difference in the repair process of building in this area under three (high, medium, and low) resource availability levels. The values of the parameters are detailed in Table 4.

### The Values of Parameters Under Different Resource Availability Levels

| Parameters | High level | Medium level | Low level |
|---|---|---|---|
| Delay in material | 1 | 2 | 5 |
| dispatch (Day) | | | |
| Maximum number of | 5,000 | 2,000 | 1,000 |
| workers | | | |
| Maximum amount of | 300 | 100 | 50 |
| equipment (Set) | | | |

Under different resource availability levels, the prediction results for each indicator are shown in Table 5.

TABLE 5
The prediction results for each indicator under different resource availability levels

| Simulation results | High level | | Medium level | | Low level | |
|---|---|---|---|---|---|---|
| Repair time (Day) | 195 | (−25.9%) | 263 | (—) | 652 | (+147.9%) |
| Total cost | 7,549.68 | (−1.8%) | 7,688.78 | (—) | 8,159.51 | (+6.1%) |
| (×10⁴ CNY) | | | | | | |
| Material consumption | 241 | (−1.1%) | 243.8 | (—) | 266.1 | (+9.1%) |
| (×10⁴ Tons) | | | | | | |
| Total number of on- | 4,963 | (+148.2%) | 2,000 | (—) | 1,000 | (−50%) |
| the-job workers | | | | | | |
| Total amount of on-the- | 112 | (+12.0%) | 100 | (—) | 50 | (−50%) |
| job equipment (Set) | | | | | | |
| (Average) Working | 0.86 | (−8.5%) | 0.94 | (—) | 2.47 | (+162.8%) |
| intensity of workers | | | | | | |
| (Average) Working | 0.85 | (−6.6%) | 0.91 | (—) | 1.78 | (+95.6%) |
| intensity of equipment | | | | | | |

It can be seen that after the working intensity of the workers or equipment is increased to a certain threshold, the efficiency cannot be improved any more. Instead, more rework will be caused due to fatigue and high-intensity work. In this case, more funds and materials are needed for the workload caused by the rework. Therefore, decision makers must thoroughly understand the general characteristics of the post-earthquake repair process of the community, so that they can plan resources that satisfy the actual construction needs at different stages of repair work, ensuring that post-earthquake repair of buildings in the community is completed efficiently.

To sum up, considering the resource dispatch and allocation process involved in the community repair process, the technical solution of this embodiment can predict and simulate the demand for resources such as workers and materials in different stages of post-earthquake repair, which is conducive to reducing the redundancy and waste of repair resources. Moreover, the repair progress and resource allocation at different levels of resource availability can be provided to simulate the allocation of repair resources during the community repair process, thereby providing decision-making support for the post-earthquake emergency repair plans. The decision makers can therefore be supported to formulate efficient and accurate post-earthquake emergency repair plans.

### Second Embodiment

This embodiment provides a system for predicting a post-earthquake repair process of building groups in a community, including:
a data preparing module, configured to obtain seismic damage states, building functions, and building areas of building groups in the community;
a building repair priority determining module, configured to determine the repair priority of each building based on functional classifications of the buildings;
a post-earthquake individual-building repair model developing module, configured to calculate a building repair workload considering the seismic damage states and building areas of the building groups in the community, and develop an individual-building repair model for simulating the repair process of an individual building under certain resource conditions; and
a community building group repair resource allocation model and post-earthquake community building group repair model developing module, configured to develop a community building group repair resource allocation model and a community building group repair system dynamics model, summarizing the repair progresses of all buildings belonging to this classification in the community according to different functional classifications, and calculating functional completeness of a functional classification of the community to predict the repair process of the building groups in the community at different levels of resource availability.

The system for predicting a post-earthquake repair process of building groups in a community in this embodiment corresponds to the method for predicting a post-earthquake repair process of building groups in a community as disclosed in the above first embodiment. The functions implemented by the functional modules in the system for predicting a post-earthquake repair process of building groups in a community correspond to process steps in the method for predicting a post-earthquake repair process of building groups in a community as disclosed in the above first embodiment. Therefore, details are not repeated here.

### Third Embodiment

This embodiment further provides an electronic device, including a processor and a memory, where the memory stores at least one instruction, and the instruction is loaded and executed by the processor to implement the method of the first embodiment.

The electronic device may vary greatly due to different configurations or performances, and may include one or more central processing units (CPUs) and one or more memories, where the memory stores at least one instruction, and the instruction is loaded by the CPU and executes the above method.

### Fourth Embodiment

This embodiment provides a computer-readable storage medium storing at least one instruction, and the instruction is loaded and executed by a processor to implement the method of the first embodiment. The computer-readable storage medium may be a ROM, a random access memory, a CD-ROM, a magnetic tape, a floppy disk, an optical data storage device, and the like. The instruction stored in the computer-readable storage medium can be loaded by a processor in a terminal and execute the above method.

Furthermore, it should be noted that the present invention may be provided as a method, an apparatus or a computer program product. Accordingly, the embodiments of the present invention may take the form of an entirely hardware embodiment, an entirely software embodiment, or a combination of software and hardware. Moreover, the embodiments of present invention may take the form of a computer program product implemented on one or more computer storage media and including computer program codes.

The embodiments of present invention are described with reference to the flowcharts and/or the block diagrams of a method, a terminal device (system), and a computer program product according to the embodiments of the present invention. It should be understood that each process and/or block in the flowcharts and/or block diagrams, as well as combinations of the processes and/or blocks in the flowcharts and/or the block diagrams, may be implemented by computer program instructions. These computer program instructions may be provided to a processor of a general-purpose computer, an embedded processor, or other programmable data processing terminal devices to produce a machine such that instructions are executed by the processor of the computer or other programmable data processing terminal devices to generate an apparatus for implementing the functions specified in one or more processes in the flowcharts and/or one or more blocks in the block diagrams.

These computer program instructions may also be stored in a computer readable memory that may direct a computer or other programmable data processing devices to function in a particular manner such that the instructions stored in the computer readable memory produce an article of manufacture including an instruction means which implements functions specified in one or more processes in the flowcharts and/or one or more blocks in the block diagrams. These computer program instructions may also be loaded onto a computer or other programmable data processing terminal devices to cause a series of operating steps to be performed on the computer or other programmable devices to produce computer-implemented processing, and the instructions executed on a computer or other programmable terminal devices provide steps for implementing the functions specified in one or more processes in the flowcharts and/or one or more blocks in the block diagrams.

It should be further noted that in this context, the term “include” or any other variations thereof are intended to cover non-exclusive inclusions such that a process, method, article, or terminal device that includes a series of elements not only includes those elements but also includes other elements that are not listed explicitly, or also include inherent elements of the process, method, article, or terminal device. In the absence of more limitations, an element defined by the sentence “including a/an . . . ” does not exclude that the process, method, article or device including the element further has other identical elements.

Finally, it should be noted that the above are the preferred embodiments of the present invention. It should be pointed out that although the preferred embodiments of the present invention have been described, for those skilled in the art, once the basic inventive concept of the present invention is known, several improvements and modifications may also be made without departing from the principles of the present invention, and these improvements and modifications also should be considered as falling within the scope of the present invention. Therefore, the appended claims are intended to be interpreted as including the preferred embodiments and all the changes and modifications that fall within the scope of the embodiments of the present invention.

What is claimed is:

1. A method for predicting and performing a post-earthquake repair process of building groups in a community, comprising:
obtaining seismic damage states, building functions, and building areas of the building groups in the community through a data preparing device;
determining a repair priority of each building based on functional classifications of the buildings through a building repair priority determining device;
calculating a building repair workload considering the seismic damage states and the building areas of the building groups in the community, and developing an individual-building repair model for simulating a repair process of an individual building under certain resource conditions through a post-earthquake individual-building repair model developing device; and
developing a community building group repair resource allocation model and a community building group repair system dynamics model, summarizing repair progresses of all buildings belonging to this classification in the community according to different functional classifications, and calculating a functional completeness of a functional classification of the community to predict the repair process of the building groups in the community at different levels of a resource availability through a community building group repair resource allocation model and post-earthquake community building group repair model developing device;
wherein the developing the individual-building repair model comprises:
developing system dynamics models of workers, equipment, materials, funds, and the repair progress for an individual-building repair respectively, by which dynamic interactions among above factors can be analyzed; and establishing system dynamics simulation equations;
wherein the system dynamics simulation equations comprise:
a worker demand=(a remaining workload>0)?((emergency funds/(a unit project cost*an average worker efficiency))>(an expected number of on-the-job workers+a total number of on-the-job workers))?(the expected number of on-the-job workers):((the emergency funds/(the unit project cost*the average worker efficiency)>the total number of on-the-job workers)?(the emergency funds/(the unit project cost*the average worker efficiency*day ( ))-the total number of on-the-job workers):(0)):(0);
a worker construction speed=the total number of on-the-job workers*an actual worker efficiency*a number of worker teams;
an equipment demand=(the remaining workload>0)?((the emergency funds/(the unit project cost*an average equipment efficiency))>(an expected amount of on-the-job equipment+a total amount of on-the-job equipment))?(the expected amount of on-the-job equipment):((the emergency funds/(the unit project cost*the average equipment efficiency)>the total amount of on-the-job equipment)?(the emergency funds/(the unit project cost*the average equipment efficiency*day ( ))-the total amount of on-the-job equipment):(0)):(0);
an equipment construction speed=the total amount of on-the-job equipment*an actual equipment efficiency*a number of equipment teams;
a material supply rate=(available materials/a material consumption per unit project)/day ( );
a material consumption rate=(an expected material input>0 && the remaining workload>0)?((the emergency funds>=the remaining workload*the material consumption per unit project*a unit material cost)?(the remaining workload*the material consumption per unit project/day ( )):((the emergency funds/(the unit project cost +0.001))*the material consumption per unit project/day ( ))):0;
a fund demand=the remaining workload>0?((a minimum guarantee of funds>the emergency funds)?(the minimum guarantee of funds−the emergency funds):0):0;
a fund consumption rate=the remaining workload>0.05?(a unit worker cost*the total number of on-the-job workers+a unit equipment cost*the total amount of on-the-job equipment)/day ( )+the material consumption rate*the unit material cost:0;
a remaining repair time=an expected repair time*(the remaining workload/a total repair workload);
an actual construction speed=(the remaining workload>0)?((a comprehensive construction speed>the remaining workload/day ( ))?(the remaining workload/day ( )):(the comprehensive construction speed)):(0);
the repair progress=1−the remaining workload/the total repair workload;
wherein day ( ) is an auxiliary amount added to adjust a unit of a variable, which is valued as 1, in a unit of day;
(a condition)? (expression 1): (expression 2) is a logical operator, if the condition is true, expression 1 will be executed, otherwise expression 2 will be executed; and
performing the post-earthquake repair process based on the community building group repair resource allocation model and the community building group repair system dynamics model.

2. The method for predicting the post-earthquake repair process of the building groups in the community according to claim 1, wherein the determining the repair priority of each building based on the functional classifications of the buildings comprises:
determining five repair priorities based on the functional classifications of the buildings, comprising:
P0: buildings that meet preset standards in terms of a correlation with a post-earthquake emergency management or rescue;
P1: an urban housing or buildings that can be used for an emergency and evacuation shelters;
P2: an infrastructure and municipal utilities:
P3: a market, a service or industrial facilities that meet preset standards in terms of an importance in providing basic life necessities to people in a disaster area and restoring a production;
P4: markets, services or industrial facilities that do not belong to P3 and can be restored through ecology;
wherein a repair urgency decreases as a priority level increases from PO to P4.

3. The method for predicting the post-earthquake repair process of the building groups in the community according to claim 1, wherein the seismic damage states of the building groups in the community comprise: a number of damaged structural and nonstructural components; and types of the damaged structural and nonstructural components.

4. The method for predicting the post-earthquake repair process of the building groups in the community according to claim 3, wherein the calculating the building repair workload considering the seismic damage states and the building areas of the building groups in the community comprises:
calculating a building repair area considering the seismic damage states and the building areas of the building groups in the community, and taking the repair area as the repair workload, wherein the repair area, i.e., areaᵣₑₚ is calculated as:
$${area}_{rep} = \frac{{\sum }_{i = 0}^{nStrCpn} {q}_{i , dmg}^{StrCpn} + β {\sum }_{i = 0}^{nNonStrCpn} {q}_{i , dmg}^{NonStrCpn}}{{\sum }_{i = 0}^{nCpn} {q}_{i}} \cdot {area}_{blg}$$
wherein nStrCpn represents a number of types of structural components in a building; NnonStrCpn represents a number of types of nonstructural components in a building; area_{blg} represents an area of the building; q_{i,dmg}^{StrCpn} represents the number of damaged structural components of an i-th type; q_{i,dmg}^{NonStrCpn} represents the number of damaged nonstructural components of the i-th type; qᵢ represents a number of structural and nonstructural components of the i-th type; β is a workload reduction factor used for calculating a workload of the nonstructural components; and nCpn represents a number of types of components.

5. The method for predicting the post-earthquake repair process of the building groups in the community according to claim 1, wherein the developing the community building group repair resource allocation model comprises:
traversing all the buildings to determine the repair progress of each individual building;
calculating actual resource demands of unrepaired buildings and classifying and queuing the unrepaired buildings according to their repair priorities; recovering workers and equipment from completely repaired buildings;
traversing repair queues of corresponding priorities according to the priority from a high level to a low level;
determining whether currently available resources satisfy resource demands of repair projects in the queues;
if there is a surplus of resources after a resource allocation, further allocating remaining resources to buildings that are in the same priority queue but are lagging in their repair progress; or, if the currently available resources do not satisfy the resource demand, allocating all resources equally, so that a repair of the all buildings in this priority queue can begin.

6. The method for predicting the post-earthquake repair process of the building groups in the community according to claim 5, wherein the repair progress is calculated as;
Fⱼⁱ=Fᵣₑₛⁱ+(1−Fᵣₑₛⁱ)*Pᵣₑₚⁱ
wherein Fⱼⁱ represents a repair progress of an i-th building of a j-th functional classification; Fᵣₑₛⁱ represents a post-earthquake functional completeness of the i-th building, i.e., a ratio of an undamaged area of the building to its total area; Pᵣₑₚⁱ represents a ratio of a repaired area of the building to its damaged area;
the functional completeness is calculated as:
$${F}_{c , func}^{j} = \frac{1}{{nBlg}^{j}} {\sum }_{i = 1}^{{nBlg}^{j}} {F}_{j}^{i}$$
wherein F_{c,func}^{j} represents a functional completeness of the j-th functional classification of the community; nBlg^{j} represents a total number of buildings of the j-th functional classification.

7. The method for predicting the post-earthquake repair process of the building groups in the community according to claim 1, wherein equations for the system dynamics model for the repair process of the building groups in the community comprise:
total allocable workers=minimum(the worker demand, maximum(0, a maximum number of workers−the number of on-the-job workers−a number of recovered workers))/(a delay in a worker dispatch)+the number of recovered workers;
total allocable equipment=minimum (the equipment demand, maximum (0, a maximum amount of equipment−the amount of on-the-job equipment−an amount of recovered equipment))/(a delay in an equipment dispatch)+the amount of recovered equipment;
total allocable materials=minimum (a materials demand/a delay in a material dispatch, a maximum number of materials).

8. The method for predicting the post-earthquake repair process of the building groups in the community according to claim 1, wherein the predicting the repair process of the building groups in the community at the different levels of the resource availability comprises: selecting three parameters of the delay in the material dispatch, a maximum amount of equipment and a maximum number of workers, limiting a total amount of community repair resources, and designing three resource levels of high, medium and low, allocating limited repair resources according to the repair priorities of the buildings, simulating the post-earthquake repair process of the building groups in the community, and displaying the repair progress and a resource allocation at the different levels of the resource availability.

9. A system for predicting and performing a post-earthquake repair process of building groups in a community, comprising:
a data preparing device, configured to obtain seismic damage states, build functions, and build areas of the building groups in the community;
a building repair priority determining device, configured to determine a repair priority of each building based on functional classifications of the buildings;
a post-earthquake individual-building repair model developing device, configured to calculate a building repair workload considering the seismic damage states and the building areas of the building groups in the community, and develop an individual-building repair model for simulating a repair process of an individual building under certain resource conditions; and
a community building group repair resource allocation model and post-earthquake community building group repair model developing device, configured to develop a community building group repair resource allocation model and a community building group repair system dynamics model, summarize repair progresses of all buildings belonging to this classification in the community according to different functional classifications, and calculate a functional completeness of a functional classification of the community to predict the repair process of the building groups in the community at different levels of a resource availability;
wherein the developing the individual-building repair model comprises:
developing system dynamics models of workers, equipment, materials, funds, and the repair progress for an individual-building repair respectively, by which dynamic interactions among above factors can be analyzed; and establishing system dynamics simulation equations;
wherein the system dynamics simulation equations comprise:
a worker demand=(a remaining workload>0)?((emergency funds/(a unit project cost*an average worker efficiency))>(an expected number of on-the-job workers+a total number of on-the-job workers))?(the expected number of on-the-job workers):((the emergency funds/(the unit project cost*the average worker efficiency)>the total number of on-the-job workers)?(the emergency funds/(the unit project cost*the average worker efficiency*day ( ))-the total number of on-the-job workers):(0)):(0);
a worker construction speed=the total number of on-the-job workers*an actual worker efficiency*a number of worker teams;
an equipment demand=(the remaining workload>0)?((the emergency funds/(the unit project cost*an average equipment efficiency))>(an expected amount of on-the-job equipment+a total amount of on-the-job equipment))?(the expected amount of on-the-job equipment):((the emergency funds/(the unit project cost*the average equipment efficiency)>the total amount of on-the-job equipment)?(the emergency funds/(the unit project cost*the average equipment efficiency*day ( ))-the total amount of on-the-job equipment):(0)):(0);
an equipment construction speed=the total amount of on-the-job equipment*an actual equipment efficiency*a number of equipment teams;
a material supply rate=(available materials/a material consumption per unit project)/day ( );
a material consumption rate=(an expected material input>0 && the remaining workload>0)?((the emergency funds>=the remaining workload*the material consumption per unit project*a unit material cost)?(the remaining workload*the material consumption per unit project/day ( )):((the emergency funds/(the unit project cost +0.001))*the material consumption per unit project/day ( ))):0;
a fund demand=the remaining workload>0?((a minimum guarantee of funds>the emergency funds)?(the minimum guarantee of funds−the emergency funds):0):0;
a fund consumption rate=the remaining workload>0.05?(a unit worker cost*the total number of on-the-job workers+a unit equipment cost*the total amount of on-the-job equipment)/day ( )+the material consumption rate*the unit material cost:0;
a remaining repair time=an expected repair time*(the remaining workload/a total repair workload);
an actual construction speed=(the remaining workload>0)?((a comprehensive construction speed>the remaining workload/day ( ))?(the remaining workload/day ( )):(the comprehensive construction speed)):(0);
the repair progress=1−the remaining workload/the total repair workload;
wherein day ( ) is an auxiliary amount added to adjust a unit of a variable, which is valued as 1, in a unit of day;
(a condition)?(expression 1):(expression 2) is a logical operator, if the condition is true, expression 1 will be executed, otherwise expression 2 will be executed; and
performing the post-earthquake repair process based on the community building group repair resource allocation model and the community building group repair system dynamics model.
